(19) United States
(12) Patent Application Publication
(10) Pub. No.: US 2025/0069359 A1
(43) Pub. Date: Feb. 27, 2025

(54) SYSTEM AND METHOD FOR PERFORMING IMAGE FEATURE EXTRACTION

(71) Applicant: KONINKLIJKE PHILIPS N.V., EINDHOVEN (NL)

(72) Inventors: Robert Gustav Trahms, Edmonds, WA (US); Earl Monroe Canfield, II, New Braunfels, TX (US)

(21) Appl. No.: 18/724,901

(22) PCT Filed: Dec. 14, 2022
(86) PCT No.: PCT/EP2022/085739

§ 371 Date: Jun. 27, 2024

Related U.S. Application Data
(60) Provisional application No. 63/294,088, filed on Dec. 28, 2021.

(51) Int. Cl. G06V 10/40; G06V 10/778; G06V 10/82

(52) U.S. Cl. CPC G06V 10/40; G06V 10/778; G06V 10/82

(57) ABSTRACT

A method for extracting features of interest from an image, including: receiving a source image (510); generating, using a first model, a simulated image based on the received source image, wherein the simulated image includes features of interest from the source image (530); detecting, using a second model, features of interest from the simulated image (540); annotating the source image based upon the detected features of interest (550); and displaying the annotated image (560).

Example embodiments disclosed herein relate to processing images to extract features using models which may be used for medical and various other applications.

### BACKGROUND

Deep Learning is a rapidly evolving branch of machine-learning algorithms that mimic the human brain and is being used in various applications. Examples include pattern recognition, natural language processing, and computer vision. Deep Learning algorithms have a distinct advantage over traditional forms of computer programming algorithms in that they can be generalized and trained to process information to achieve an intended purpose. This alleviates the need to write custom computer code. Moreover, the models implemented based on the algorithms may continue to learn as the number of use cases increase. This, in turn, allows the models to generate more accurate results.

### SUMMARY

Various embodiments relate to a method for extracting features of interest from an image, including: receiving a source image; generating, using a first model, a simulated image based on the received source image, wherein the simulated image includes features of interest from the source image; detecting, using a second model, features of interest from the simulated image; annotating the source image based upon the detected features of interest; and displaying the annotated image.

Various embodiments are described, wherein the first model is an autoencoder.

Various embodiments are described, wherein the first model is a sparse encoder.

Various embodiments are described, wherein the sparse encoder is a neural network.

Various embodiments are described, wherein second model is a neural network.

Various embodiments are described, wherein the source image is a patient image and wherein the simulated image masks identification of the patient associated with the patient image.

Various embodiments are described, wherein the second model is trained using a set of simulated images generated by the first model based upon a training set of source images.

Further various embodiments relate to a method for training an imaging system, including: receiving a first set of training source images;
training a first model using the set of training source images, wherein the first model is an autoencoder configured to generate simulated images based upon images input into the autoencoder, wherein the simulated images include features of interest from the source images; receiving a plurality of sets of training source images; inputting the plurality of sets of training source images into the first model to produce a first set of training simulated images; transmitting the first set of training simulated images to a labeling system; receiving labeled first set of training simulated images from the labeling system; and training a second model using the labeled first set of training simulated images, wherein the second model is configured to detect features of interest from images input into the first model.

Various embodiments are described, wherein the plurality of sets of training sources images are received from different sources at different times.

Various embodiments are described, wherein the first model is a sparse encoder.

Various embodiments are described, wherein the sparse encoder is a neural network.

Various embodiments are described, wherein second model is a neural network.

Various embodiments are described, wherein the first set of training source images and the plurality of sets of training source images are patient images and wherein the simulated images associated with the first set of training source images and plurality of sets of training source images masks identification of the patient associated with the patient images.

Various embodiments are described, wherein the first model is trained using unsupervised learning method.

Various embodiments are described, further including: receiving a second set of training source images; inputting the second set of training source images into the first model to produce a second set of training simulated images; transmitting the second set of training simulated images to a labeling system; receiving labeled second set of training simulated images from the labeling system; and re-training the second model using the labeled first set of training simulated images and the labeled second set of training simulated images.

Further various embodiments relate to a system for extracting features of interest from an image, including: a memory configured to store instructions; and a controller configured to execute the instructions to: receive a source image; generate, using a first model, a simulated image based on the received source image, wherein the simulated image includes features of interest from the source image; detect, using a second model, features of interest from the simulated image; annotating the source image based upon the detected features of interest; and display the annotated image.

Various embodiments are described, wherein the first model is an autoencoder.

Various embodiments are described, wherein the first model is a sparse encoder.

Various embodiments are described, wherein the sparse encoder is a neural network.

Various embodiments are described, wherein second model is a neural network.

Various embodiments are described, wherein the source image is a patient image and wherein the simulated image masks identification of the patient associated with the patient image.

Various embodiments are described, wherein the second model is trained using a set of simulated images generated by the first model based upon a training set of source images.

Further various embodiments relate to a system for training an imaging system, including: a memory configured to store instructions; and a controller configured to execute the instructions to: receive a first set of training source images; train a first model using the set of training source images, wherein the first model is an autoencoder configured to generate simulated images based upon images input into the autoencoder, wherein the simulated images include features of interest from the source images; receiving a plurality of sets of training source images; input the plurality of sets of training source images into the first model to produce a first set of training simulated images; transmit the first set of training simulated images to a labeling system; receive labeled first set of training simulated images from the labeling system; and train a second model using the labeled first set of training simulated images, wherein the second model is configured to detect features of interest from images input into the first model.

Various embodiments are described, wherein the plurality of sets of training sources images are received from different sources at different times.

Various embodiments are described, wherein the first model is a sparse encoder.

Various embodiments are described, wherein the sparse encoder is a neural network.

Various embodiments are described, wherein second model is a neural network.

Various embodiments are described, wherein the first set of training source images and plurality of sets of training source images are patient images and wherein the simulated images associated with the first set of training source images and plurality of sets of training source images masks identification of the patient associated with the patient images.

Various embodiments are described, wherein the first model is trained using unsupervised learning method.

Various embodiments are described, wherein the controller is further configured to execute the instructions to: receive a second set of training source images; input the second set of training source images into the first model to produce a second set of training simulated images; transmit the second set of training simulated images to a labeling system; receive labeled second set of training simulated images from the labeling system; and re-train the second model using the labeled first set of training simulated images and the labeled second set of training simulated images.

### BRIEF DESCRIPTION OF THE DRAWINGS

Additional objects and features of the invention will be more readily apparent from the following detailed description and appended claims when taken in conjunction with the drawings. Although several example embodiments are illustrated and described, like reference numerals identify like parts in each of the figures, in which:

FIG. 1 shows an embodiment of an imaging system;

FIG. 2 shows an embodiment of a first model;

FIG. 3 illustrates an embodiment of the imaging system including a sparse encoder;

FIG. 4 illustrates an embodiment of an ultrasound imaging system for processing ultrasound images for patients in the field;

FIG. 5 illustrates an embodiment of a method for analyzing a patient images; and

FIG. 6 shows an embodiment of an imaging system.

### DETAILED DESCRIPTION

It should be understood that the figures are merely schematic and are not drawn to scale. It should also be understood that the same reference numerals are used throughout the figures to indicate the same or similar parts.

The descriptions and drawings illustrate the principles of various example embodiments. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various example embodiments described herein are not necessarily mutually exclusive, as some example embodiments can be combined with one or more other example embodiments to form new example embodiments. Descriptors such as “first,” “second,” “third,” etc., are not meant to limit the order of elements discussed, are used to distinguish one element from the next, and are generally interchangeable. Values such as maximum or minimum may be predetermined and set to different values based on the application.

Privacy issues continue to be a concern of patients in the healthcare industry. While this is understandable, at the same time restrictions put in place to protect patient privacy limit the use of patient data to develop robust computer models for many medical applications. For example, in order to produce meaningful decisions or data, the models must be trained with actual patient information. This information is often not available in quantities sufficient enough to train a model with desired accuracy. As a result, the application of artificial intelligence, in general, to the medical field suffers, which, in turn, adversely affects the ability of doctors, researchers, and technicians to provide adequate patient care.

One or more embodiments described herein provide a system and method for simulating information that may be used to train a model for an intended application. In one embodiment, the intended application is a medical application. The example of an ultrasound application will be discussed below, but other embodiments may apply to different types of medical applications or any other image-processing application even if unrelated to the medical field.

Generating accurate models in the field of ultrasound images has presented particular challenges because of the lack of training data due to privacy issues. For example, training of anatomically-aware deep neural networks used in ultrasound anatomy detection should be based on a collection of relevant ultrasound images from a statistically significant group of clinical sources, e.g., clinics under contract that conduct ultrasound examinations. However, this is often not possible because the collected ultrasound images are required to follow restrictive data privacy guidelines, which limits the number of image samples being available to train a model, and this data may also be only available for short period of time. These challenges may be overcome in accordance with one or more system and method embodiments described herein.

In order to address these privacy limitations, a sparse encoder may be used to simulate images that are then used to train the anatomically-aware deep neural networks. The sparse encoder will take an image in and produce a simulated image that retains the key features of the input image. These key features may include, for example, a fetal heart, fetal head, fetal femur, etc. In the simulated image, the key features remain in the same location, but other detailed information that might be used to identify a specific image and hence a patient is removed. This occurs because the sparse encoder takes in a large number of inputs, feeds them through constrained or narrow hidden layers of the sparse encoder, and then produces an output image of similar size as the input image. The constrained hidden layers will cause an output to be produced with the important anatomical features or features of interest, but will remove other identifying non-essential information. This allows for the privacy of the patients whose images are used to train the sparse encoder to be maintained. The sparse encoder acts as a one-way function that eliminates any connection between the input and output data and prevents a party from using the outputs of the sparse encoder to reconstruct the original image used to generate the outputs. These simulated images may then be used to train the anatomically-aware deep neural network. The sparse encoder may be trained using unsupervised learning.

As data becomes available for training purposes from different data sources and sites at different times, these different sets of data can be run through the sparse encoder to generate additional simulated images that increase the training set for use in training the anatomically-aware deep neural networks. As a result, a larger number of input images becomes available to be used to improve the training of the anatomically-aware deep neural network while maintaining patient privacy.

Because the outputs of the sparse encoder still resemble a sonogram of a fetus, a subject matter expert may review the simulated images and label various features found in the simulated images. For example, the subject matter expert may place bounding boxes around features and provide a label of the feature in the bounding box. Once a sufficient number of labeled simulated images have been generated, the anatomically-aware deep neural network may be trained using the simulated images via supervised learning.

When the imaging system is in use, an image is captured and fed into the sparse encoder. The sparse encoder acts as a preprocessing step before the anatomically-aware deep neural networks. The output of the sparse encoder is then fed into the anatomically-aware deep neural network to produce the feature identification or features of interest (e.g., object identification/classification and location) that the anatomically-aware deep neural network is trained to produce. Embodiments of this system will now be described in greater detail below.

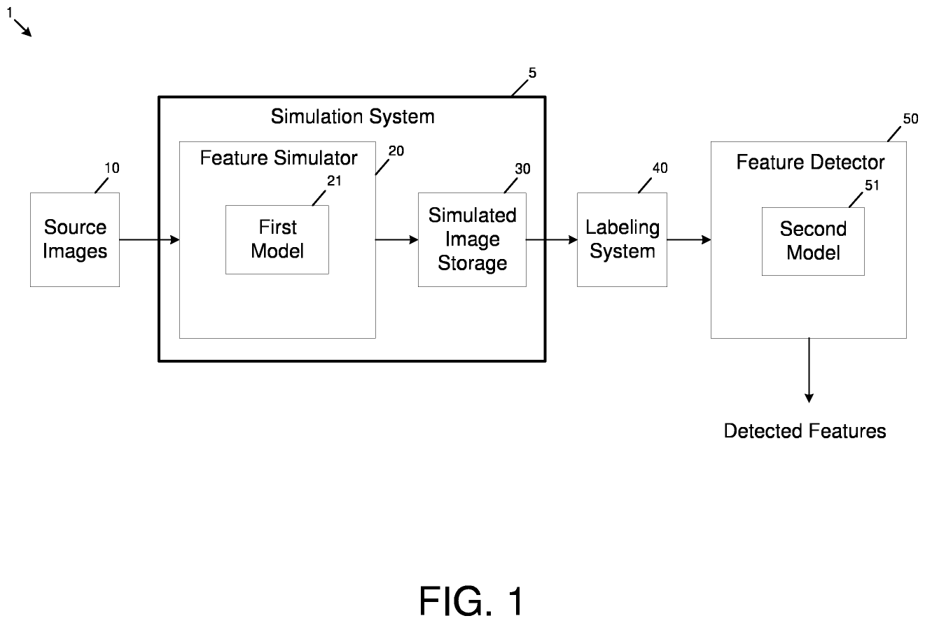

FIG. 1 illustrates an embodiment of an imaging system 1 that uses artificial intelligence techniques to simulate information that may be used to train a model. The imaging system 1 may include a simulation system 5 and a feature detector 50. In one example, the simulated images include representations of anatomical features that may be found in ultrasound images. The simulated images may be incorporated into one or more datasets for training a second model 51 that is used to detect corresponding features of interest of ultrasound images of patients taken in a clinical setting.

The features of interest may be, for example, the features (e.g., arms, legs, head, hands, etc.) of a baby in the womb of a mother receiving an ultrasound test at a medical center. In other embodiments, the features of interest may relate to various other types or characteristics of the human anatomy relating to the purpose of the ultrasound procedure. Examples include, but are not limited to, the diagnosis of birth defects, uterine or ovarian abnormalities, gallbladder disease, tumor evaluation, blood flow issues, thyroid gland evaluation and metabolic bone disease, as well as other uses. The simulated images may include representations of one or more anatomical features that may be used to train the ultrasound model.

During training of the simulation system 5, a first set of actual images of ultrasounds of patients are only used to train of the simulation model to generate representations of simulated features, and the actual images are not used by the second model when implemented in the field. This protects the privacy of patients whose images serve as the source images that are used in the datasets to train the simulation model. After training has been completed, the actual images may be discarded.

Referring to FIG. 1, the simulation system 5 may be coupled between a first storage device 10 and a labelling system 40. The first storage device may be a memory or database storing a plurality of source images that contain anatomical features of interest to the intended application. In this case, the intended application is an ultrasound of expectant mothers and the features are various body parts of babies appearing in actual ultrasound images taken of the mothers. The source images thus serve as training datasets for a first model of the simulation system. The labeling system 40 facilitates labeling of the features in the simulation system output.

The simulation system 5 includes a feature simulator 20 and a simulated image storage device 30. The feature simulator 20 includes a first model 21 (which may be the sparse encoder discussed elsewhere herein) that is trained using a first data set include patient source images to generate simulated images with simulated features corresponding to features found in the source images of the training datasets. The specific type of training used may depend on the type of model being implemented. Once the first model is trained using a first training data set, it outputs sets of simulated images which include different selected anatomical features that are represented in the corresponding source images. For example, some of the simulated features may represent arms of babies, which arms may vary in size or appearance, for example, depending on the state of development of the babies at the time the source images were acquired. The same variance may exist for the other anatomical features of interest. The first model may be trained to generate simulated images that include simulated features, and the simulated images are stored in the simulated image storage device 30. Examples of the first model 21 are discussed below in relation to additional embodiments.

The labeling system 40 facilitates the labeling of the simulated anatomical features stored in the simulated image storage device 30. This may be performed in a variety of ways. For example, in one embodiment information for generating the labels may be received based on information manually input by a subject matter expert (e.g., medical professional) into a processing system (e.g., computer system) coupled to receive the simulated images from the simulated image storage device 30. In this situation, the simulated images may be presented to the subject matter expert on a display, and the subject matter expert identifies features and labels the features. This may be done by drawing a bounding box around a feature. In another embodiment, the simulated features may be automatically identified and labeled by an application program of the imaging system. This may be accomplished, for example, based on meta information or other data included with the simulated images that may help identify the simulated features in the simulated images generated by the first model 21. Once the simulated features have been identified and labeled, they may be stored for use in training a feature detector 50.

The feature detector 50 includes a second model 51 which may be a anatomically-aware deep neural network. The anatomically-aware deep neural network may be any known or new neural network that may be trained using input images to classify various anatomical features or features of interest in the simulated images to determine, for example, whether any inconsistencies or malformities exist, the state of development of the baby, the sex of the baby, and/or other information of interest.

Instead of using the source images 10, the second model 51 is trained based on the simulated features generated and output from the simulation system 5. Use of the simulated images protects the privacy interests of patients who consented to or otherwise allowed their ultrasounds images to be used for training of the second model 51. As training images become available, they may be input into the trained simulation system 5 to add new simulated images to the simulated images already stored in the simulated image storage 30. Then the original images can be deleted. As a result, the simulated image storage 30 may collect a large number of simulated images using patient images from a number of different data sets that become available at different times. Data privacy of the patients is maintained, as only the simulated images are stored and the original images are not maintained. As the collection of simulated images grows, it may be used to retrain the second model 51 to improve the performance and accuracy of the second model 51.

During actual operation of the imaging system, received ultrasound images may be input into the simulation system 5, and the output of the simulation system 5 is then input into the second model 51 to produce the desired feature of interest, such as whether any inconsistencies or malformities exist, the state of development of the baby, the sex of the baby, and/or other information of interest.

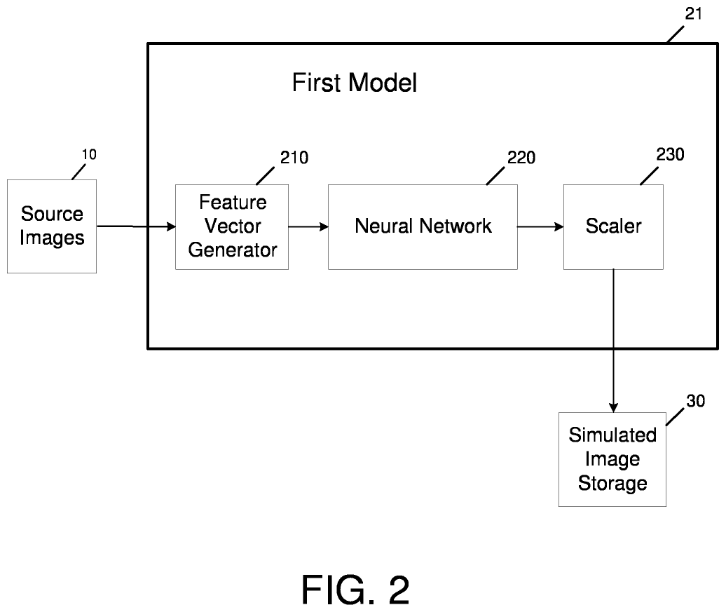

FIG. 2 shows an embodiment of the first model 21 including a feature vector generator 210, a neural network 220, and a scaler 230. The feature vector generator 210 is coupled to receive the source images 10 from an image storage device. For each source image, the feature vector generator may, for example, register the image and normalize the grayscale values of the pixels therein. Then the feature vector generator 210 may generate the input feature vector for the input image. The feature vector may include a grey scale value for each image pixel, color information for each pixel if available, and other meta data related to the image that may be expressed in numerical form and arranged, for example, in a vector.

The neural network 220 may be, for example, an autoencoder neural network trained using an unsupervised learning algorithm. One example of such an autoencoder neural network is a sparse encoder. This type of encoder may generate spatially correlated feature data that is non-traceable from the original images, thus preserving the privacy of the patients from which the source images were derived. An embodiment of a sparse encoder used to implement the neural network for purposes of generating the simulated images for use in training the second model is discussed below.

The scaler 230 may scale the simulated images output from the neural network, for example, to match a predetermined data format which may be compatible for labeling and/or processing by the second model. The scaled simulated images output may then be stored in image storage 30 for subsequent use, as described below.

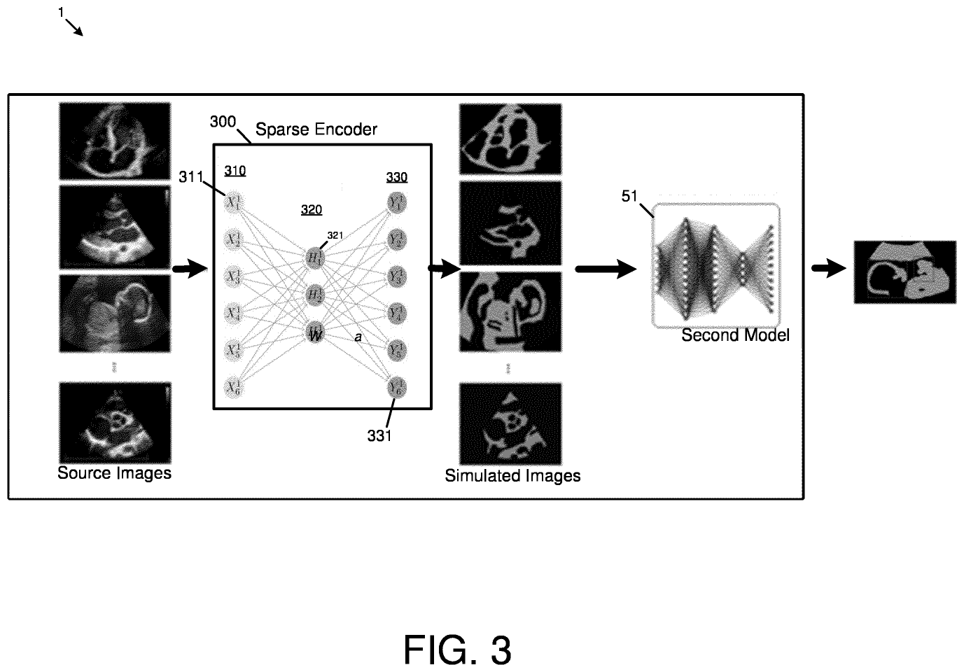

FIG. 3 shows an embodiment of the imaging system implemented to include a sparse encoder 300. In this embodiment, the sparse encoder includes three layers: an input layer 310, a hidden encoding layer 320, and an output layer 330 for decoding. The sparse encoder may have more than one hidden layer for encoding in another embodiment.

The input 310 layer includes a plurality of input nodes 311 that respectively correspond to the feature vectors Xⱼⁿ output from the feature vector generator 210 for the ultrasound source images 10, where j corresponds to an index in the feature vector for the source image and where n corresponds to a specific source image. In this example, six nodes 311 are included to corresponding to a feature vector having six inputs X₁¹ to X₆¹ for convenience in showing the architecture of the sparse encoder 300. In other embodiments, additional input nodes 311 may be included in the input layer 310. Each input node 311 may apply a weight to the input value and then add a bias value. This value may then be input into an activation function. Any activation function may be used, including for example, a sigmoid function, a rectified linear unit, etc.

In operation, the outputs of the input nodes 311 of the first layer 310 are input into each of the hidden nodes 321 of the hidden encoding layer 320. A matrix of weights W and biases may be applied to each of the inputs of each hidden node 321 resulting in a linear combination of the inputs, and again an activation may be applied to the linear combination of the inputs. In this example, three hidden nodes 321 are used for convenience, but the number of hidden nodes may be different in another embodiment. Further, additional hidden layers may be used as well in other embodiments. As this is a sparse encoder 300, the number of hidden nodes 321 will be fewer than each of the number of input nodes 311 and the number of output nodes 331. Often the number of hidden node 321 will be significantly lower than the number of input nodes 311 and the number of output nodes 331. This lower number of hidden nodes 321 is what allows for the sparse encoder to focus on the significant features of the input images and discard the less significant features so that the patients privacy may be maintained. In this way, the sparse encoder acts as a one-way function that eliminates any connection between the input and output data and prevents a party from using the outputs of the sparse encoder to reconstruct the original image used to generate the outputs.

Each of the hidden nodes 321 in the hidden encoding layer are coupled to each of the output nodes 331 in the output layer 330. The output nodes 331 may operate like the other nodes in the system by combining the input values using weights and bias values and then using an activation function to produce the output. Again the number of output nodes 331 is shown as six for convenience, but in other embodiments a different number of output nodes is possible. Further, the number of input nodes 311 and hence input values may be different from the number of output nodes 331 and hence output values. Further, the number of hidden nodes 321 will be some fraction of the number of input nodes 311. As fewer hidden nodes 321 are used, the similarity between the input and the output decreases, allowing for greater privacy, but potentially resulting in the loss of desired features of interest in the output. As more hidden nodes 321 are used, the similarity between the input and the output increase, resulting in less privacy, but potentially resulting in better feature extraction from the input image. Hence, the number of hidden nodes 321 may be selected to balance between privacy and feature extraction accuracy.

Given unlabeled training examples set {x (1), x(2), x(3), . . . }, where x(i)∈ [symbol] ⁿ, and input at first layer 310, the sparse encoder 300 is trained using an unsupervised learning algorithm with backpropagation, setting the target values to be equal to the inputs. The sparse encoder tries to learn a function which is an approximation to the identity function, so as to output y that is similar to x. For example, suppose the inputs x are pixel intensity values with a limited number of hidden layers. Because there are only limited number of hidden nodes 321, the network is forced to learn a compressed representation of the input. For example, given only a vector of hidden node outputs, the output layer 330 will try to reconstruct the image input x.

The constraint on the network (as mentioned above) may be referred to as a sparsity constraint on the hidden units. Given the sparsity constraint, the sparse encoder 300 will generate the simulated image 30 from the output nodes 331 in the output layer 330. Thus, the sparse encoder 300 may operate as a feature extractor generating simulated images that retain the anatomical features of interest from input ultrasound images that may be used as a basis for training a feature detector 50 in the imaging system 1.

Returning to FIG. 2, the scaler 230 may optionally scale the simulated images for storage in the simulated image storage device 30. The scaling may be performed, for example, to be compatible for training with the second model 51.

The second model 51 of FIG. 1 may be, for example, a deep-learning neural network (DNN) which is trained based on the simulated images generated by the simulation system 5. In FIG. 3, an example is shown of the second model 51, where the second model 51 is a DNN model that operates as a classifier to generate features of interest that might, for example, that identify specific anatomical features and their location.

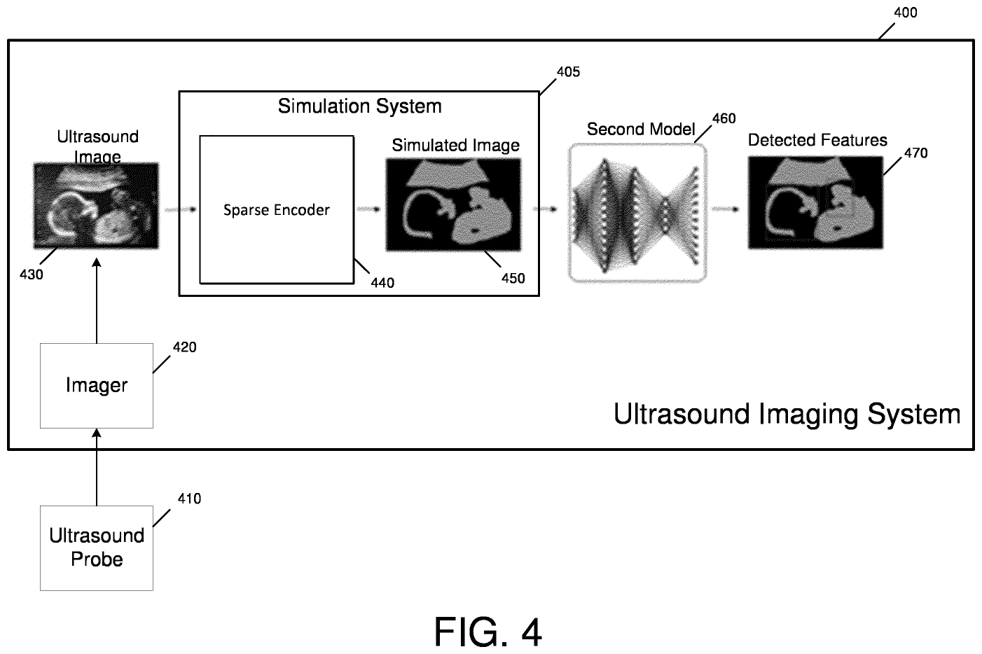

FIG. 4 illustrates an ultrasound imaging system 400 for processing ultrasound images for patients in the field, e.g., in a clinical setting where patients are receiving care. The ultrasound imaging system 400 includes a simulation system 405 and a second model 460 like those described above.

Referring to FIG. 4, the signal path of the system 400 includes an ultrasound probe 410 which generates signals that are input into an imager 420 for generating a live ultrasound image 430. The live ultrasound image 430 is input into the sparse encoder 440, which has been trained as previously explained. The sparse encoder 440 generates a simulated image 450 of the live ultrasound image 430 e.g., which includes extracted features from the live image 430. The simulated image 450 may then be input into the second model (e.g., DNN) 460, which has been previously trained based on datasets of simulated features generated by the sparse encoder. The DNN generates features of interest that may include, for example, predictions of one or more anatomical features, which may be incorporated into an output image 470 labeled with those predicated features, for example, by bounding boxes. Because the sparse encoder is incorporated within the ultrasound machine (or its processing system) within the field, the sparse encoder may continue to generate more simulated images over time that then may be used to retrain the second model 460.

It is noted that the system 400 may also take as inputs stored previously captured ultrasound images that need to be processed and evaluated.

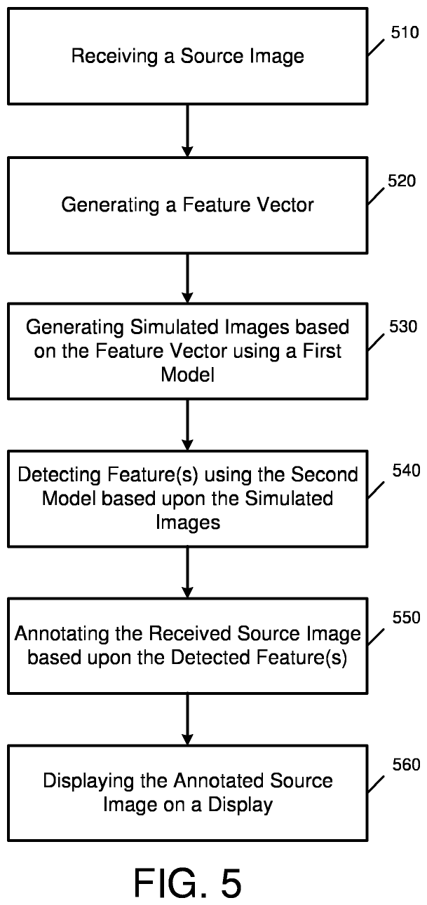

FIG. 5 illustrates an embodiment of a method for analyzing a patient images using any of the system embodiments described herein. At 510, a source image is received. In an ultrasound application, the image may be an ultrasound image with anatomical features such as in an ultrasound examination of an expectant mother or may be tumors or other features of interest in the body. At 520, a feature vector based upon the source image is generated. At 530, a first model is used to generate simulated images based on the feature vector. The first model may be implemented as described above. The first model generates the simulated image in a manner which masks identification of the patient from which the source image was derived (e.g., the features found in the simulated image are untraceable back to the patient), thus protecting their identity.

At 540, the simulated image is input into the second model of a feature detector to detect features of interest in the simulated image. Then, at 550, the received source image may be annotated based upon the detected features. Finally, at 560, the annotated source image may be displayed on a display.

The ultrasound imaging system may be used to perform ultrasound examinations and thus may be incorporated into the processing architecture of an ultrasound machine. The ultrasound imaging system may be incorporated into a controller of the ultrasound machine or a processor locally or remotely coupled to the ultrasound machine.

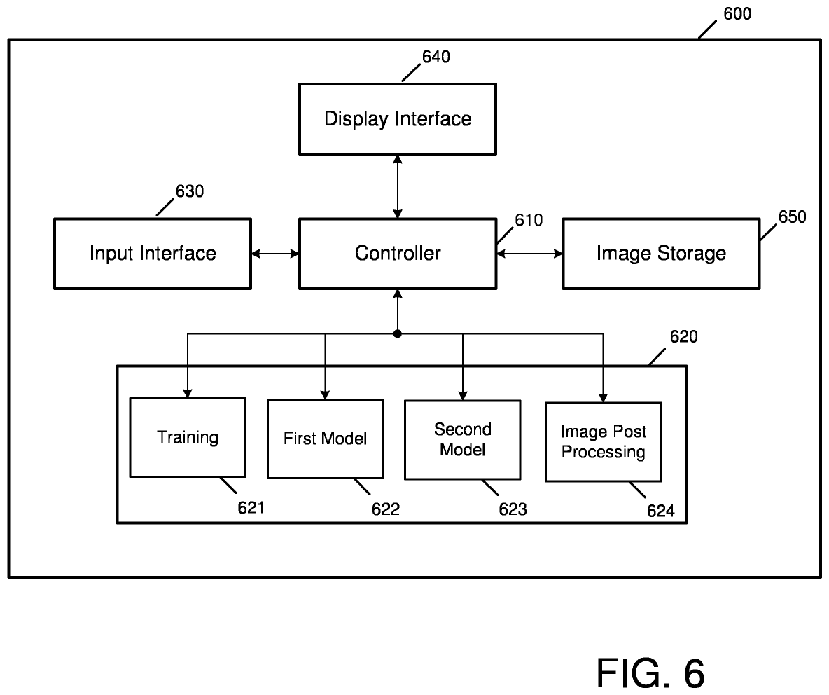

FIG. 6 shows an embodiment of an imaging system 600 which uses artificial intelligence techniques to extract features from an image. This imaging system 600 includes a controller 610, a memory 620, an input interface 630, a display interface 640, and image storage 650. The controller 610 may execute instructions stored in the memory 620 for performing operations of the embodiments described herein. The memory 620 may store training instructions 621, first model instructions 622, second model instructions 623, and image post processing instructions 624. The training instruction 621 may include instructions for training the first and second models as described above. These instructions may also include the instructions that implement the labeling function where simulated images are labeled to allow for training of the second model. Further, the training instructions may include instructions for retraining the second model as more training simulated images are acquired. The first model instructions 622 include the instructions and data (e.g., model weights, parameters, and model structure) to implement the first model which may be a sparse encoder. The second model instructions 623 include the instructions and data (e.g., model weights, parameters, and model structure) to implement the second model which extracts features of interest from the simulated image. The image post processing instructions 624 take the extracted feature(s) from the second model and annotates the input image, which then may be displayed to a user of the imaging system.

The input interface 630 may be connected to an ultrasound probe and receive data signals produced by the ultrasound probe. Also the input interface 630 may receive input images from other sources external to the imaging system, for example from an image storage system, that are to be processed. Further, the input interface 630 may also receive inputs from a user that may be used to control the imaging system 600 as well as providing inputs during the labeling of simulated images.

The display interface 640 interfaces with a display where images may be presented. The display interface 640 may facilitate the display of image annotations generated by the image post processing instructions 624.

While the imaging system has been described using the example of ultrasound images, the imaging system herein may also be applied to any other type of images that are processed to extract and/or identify features may be interest to use, but where there are privacy concerns related to the available data available to train the imaging system. For example, the imaging system may be applied to other types of medical images include X-rays, magnetic resonance images, CAT scans, etc. The imaging system may be applied to pictures of consumers, where the privacy of the consumer is to be preserved. Also, the imaging system may be applied when classified or other sensitive images are used to train a feature extraction model that then may be used on unclassified images or less sensitive images. The imaging system may further be applied in any situation where sufficient data is not available at one time to train the feature extraction model, but sufficient data is available to train a sparse encoder that produces simulated images, and the simulated images may be generated over time from different data sets until a sufficient number of simulated images are available to train the feature extraction model.

In accordance with one or more of the aforementioned embodiments, the methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods described herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the operations of the system and method embodiments described herein.

The processors, systems, controllers, generators, labelers, simulators, models, networks, scalers, and other signal-generating and signal-processing features of the embodiments described herein may be implemented in logic which, for example, may include hardware, software, or both. When implemented at least partially in hardware, the processors, systems, controllers, generators, labelers, simulators, models, networks, scalers, and other signal-generating and signal-processing features may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the processors, systems, controllers, generators, labelers, simulators, models, networks, scalers, and other signal-generating and signal-processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Although the various exemplary embodiments have been described in detail with particular reference to certain exemplary aspects thereof, it should be understood that the invention is capable of other example embodiments and its details are capable of modifications in various obvious respects. As is apparent to those skilled in the art, variations and modifications can be affected while remaining within the spirit and scope of the invention. The embodiments may be combined to form additional embodiments. Accordingly, the foregoing disclosure, description, and figures are for illustrative purposes only and do not in any way limit the invention, which is defined by the claims.

1. A method for extracting features of interest from an image, comprising:
receiving a source image;
generating, using a first model, a simulated image based on the received source image, wherein the simulated image includes features of interest from the source image;
detecting, using a second model, features of interest from the simulated image;
annotating the source image based upon the detected features of interest; and
displaying the annotated image.

2. The method of claim 1, wherein the first model is an autoencoder.

3. The method of claim 1, wherein the first model is a sparse encoder.

4. The method of claim 3, wherein the sparse encoder is a neural network.

5. The method of claim 1, wherein second model is a neural network.

6. The method of claim 1, wherein the source image is a patient image and wherein the simulated image masks identification of the patient associated with the patient image.

7. The method of claim 1, wherein the second model is trained using a set of simulated images generated by the first model based upon a training set of source images.

8. A method for training an imaging system, comprising:
receiving a first set of training source images;
training a first model using the set of training source images, wherein the first model is an autoencoder configured to generate simulated images based upon images input into the autoencoder, wherein the simulated images include features of interest from the source images;
receiving a plurality of sets of training source images;
inputting the plurality of sets of training source images into the first model to produce a first set of training simulated images;
transmitting the first set of training simulated images to a labeling system;
receiving labeled first set of training simulated images from the labeling system; and
training a second model using the labeled first set of training simulated images, wherein the second model is configured to detect features of interest from images input into the first model.

9. The method of claim 8, wherein the plurality of sets of training sources images are received from different sources at different times.

10. The method of claim 8, wherein the first model is a sparse encoder.

11. The method of claim 10, wherein the sparse encoder is a neural network.

12. The method of claim 8, wherein second model is a neural network.

13. The method of claim 8, wherein the first set of training source images and the plurality of sets of training source images are patient images and wherein the simulated images associated with the first set of training source images and plurality of sets of training source images masks identification of the patient associated with the patient images.

14. The method of claim 8, wherein the first model is trained using unsupervised learning method.

15. The method of claim 8, further comprising:
receiving a second set of training source images;
inputting the second set of training source images into the first model to produce a second set of training simulated images;
transmitting the second set of training simulated images to a labeling system;
receiving labeled second set of training simulated images from the labeling system; and
re-training the second model using the labeled first set of training simulated images and the labeled second set of training simulated images.

16. A system for extracting features of interest from an image, comprising:
a memory configured to store instructions; and
a controller configured to execute the instructions to:
receive a source image;
generate, using a first model, a simulated image based on the received source image, wherein the simulated image includes features of interest from the source image;
detect, using a second model, features of interest from the simulated image;
annotating the source image based upon the detected features of interest; and
display the annotated image.

17. The system of claim 16, wherein the first model is an autoencoder.

18. The system of claim 16, wherein the first model is a sparse encoder.

19. The system of claim 18, wherein the sparse encoder is a neural network.

20. The system of claim 16, wherein second model is a neural network.

21. The system of claim 16, wherein the source image is a patient image and wherein the simulated image masks identification of the patient associated with the patient image.

22. The system of claim 16, wherein the second model is trained using a set of simulated images generated by the first model based upon a training set of source images.

23. A system for training an imaging system, comprising:
a memory configured to store instructions; and
a controller configured to execute the instructions to:
receive a first set of training source images;
train a first model using the set of training source images, wherein the first model is an autoencoder configured to generate simulated images based upon images input into the autoencoder, wherein the simulated images include features of interest from the source images;
receiving a plurality of sets of training source images;
input the plurality of sets of training source images into the first model to produce a first set of training simulated images;
transmit the first set of training simulated images to a labeling system;
receive labeled first set of training simulated images from the labeling system; and
train a second model using the labeled first set of training simulated images, wherein the second model is configured to detect features of interest from images input into the first model.

24. The system of claim 23, wherein the plurality of sets of training sources images are received from different sources at different times.

25. The system of claim 23, wherein the first model is a sparse encoder.

26. The system of claim 25, wherein the sparse encoder is a neural network.

27. The system of claim 23, wherein second model is a neural network.

28. The system of claim 23, wherein the first set of training source images and plurality of sets of training source images are patient images and wherein the simulated images associated with the first set of training source images and plurality of sets of training source images masks identification of the patient associated with the patient images.

29. The system of claim 23, wherein the first model is trained using unsupervised learning method.

30. The system of claim 23, wherein the controller is further configured to execute the instructions to:
receive a second set of training source images;
input the second set of training source images into the first model to produce a second set of training simulated images;
transmit the second set of training simulated images to a labeling system;
receive labeled second set of training simulated images from the labeling system; and
re-train the second model using the labeled first set of training simulated images and the labeled second set of training simulated images.
